(19) United States
(12) Patent Application Publication
(10) Pub. No.: US 2007/0096004 A1
(43) Pub. Date: May 3, 2007

(54) Umbrella mount

(76) Inventor: Magin Luis Quiambao Jr, Harpers Ferry, WV (US)

Correspondence Address: STEPTOE & JOHNSON, CHASE TOWER, 6TH FLOOR, P.O. BOX 2190, CLARKSBURG, WV, 26302-2190, US

(21) Appl. No.: 10/561,880

(22) PCT Filed: Jun. 23, 2004
(86) PCT No.: PCT/US04/20354

§ 371 Date: Dec. 23, 2005

Related U.S. Application Data
(60) Provisional application No. 60/482,124, filed on Jun. 23, 2003.

(51) Int. Cl. F16M 13/00; A47G 25/12

(52) U.S. Cl. 248/534; 248/523

(57) ABSTRACT

An umbrella mount adapted to hold an umbrella shaft and to be detachably mounted to a support shaft such as a rear leg of a folding chair, lawn chair, or beach chair. The umbrella mount comprises a tube, a top binder, a bottom binder, a support member, and a securing member. The top binder detachably attaches the tube near its top end to the support shaft, whereas the bottom binder detachably attaches the tube near its bottom end to the support shaft. The binders are preferably hook and loop straps with non-slip collars. The bottom of the umbrella shaft is deposited into the tube. The support member prevents the umbrella shaft from slipping out the bottom end of the tube. The securing member adjusts to secure the umbrella shaft within the tube.

### CROSS-REFERENCES TO RELATED APPLICATIONS

This application claims the benefit of U.S. Provisional Application No. 60/482,124, filed Jun. 23, 2003.

### BACKGROUND OF THE INVENTION

1. Field of the Invention

This invention relates to devices for holding umbrellas, and in particular, to a portable device which can be mounted to a support shaft, e.g., a chair leg, and is adapted for receiving and supporting an umbrella.

2. Description of the Related Art

It is often desirable to have an umbrella close at hand for relief from rain as well as from direct sunlight. This is especially true when watching an outdoor sporting event, e.g., a soccer or baseball game, or a motorcar race. At such times, it also is desirable to be able to mount or plant such an umbrella in an upright, unfolded position to or in a suitably stable object such that a user of the umbrella need not fatigue his or her arms and hands by holding and maintaining the umbrella in the desired position. To that end, a conventional beach umbrella or sun shade umbrella typically has a pointed pole that can be driven into the sand at a beach to immobilize the umbrella However, in locations where the ground is not as soft, e.g., dirt fields or pavement, it is usually impractical or impossible to attempt to anchor the umbrella in the ground. In these locations, an alternative mounting option is desirable. Thus, there is a need for a portable, light-weight umbrella mounting device that can be easily and quickly installed and removed from a support shaft, e.g., a portable chair leg.

Various devices are disclosed in the literature for mounting an umbrella to a free-standing structure, thereby eliminating the need for anchoring the umbrella to the ground. However, the prior art devices are often cumbersome, heavy, or large, or require time and/or tools to install and remove such a prior art umbrella mounting device. For example, U.S. Pat. No. 6,474,097 issued on Nov. 5, 2002, to Treppedi et al. shows a mobile cooler having a cylindrical umbrella shaft retainer with a retaining knob that holds an umbrella either in a raised position above the ground during transport or in place when the umbrella shaft is embedded in the ground. However, Treppedi et al. does not show an umbrella mounting device that is detachably mounted to a support shaft, that can be re-positioned along a support shaft, or that maintains the umbrella shaft above the ground surface at all times.

Turning now specifically to umbrella mounting devices used in conjunction with chairs, U.S. Pat. No. 3,637,046 issued on Jan. 25, 1972, to Emmons discloses the use of a U-bolt clamp to secure an umbrella shaft to a chair. The Emmons device requires a hole to be bored in the chair seat to maintain the umbrella in an upright position, as well as holes and/or a permanently attached U-bolt clamp on the seat to anchor the umbrella shaft.

U.S. Pat. No. 3,904,161 issued on Sep. 9, 1965, to Scott discloses a clamp for attaching an umbrella to a lawn chair. The Scott device must be attached to a horizontal portion of the chair frame, preferably the uppermost horizontal portion of the chair back, and its jaws clamp a relatively small portion of the handle of an umbrella with no further stabilization of the umbrella shaft at any other point along the umbrella shaft.

U.S. Pat. No. 4,871,141 issued on Oct. 3, 1989, to Chen discloses an adjustable umbrella support that clamps on the side of a chair. An umbrella shaft is simply deposited into a hole bored through most of the length of the device. No further means of more securely attaching the umbrella shaft to the device are shown.

U.S. Pat. No. 5,100,198 issued on Mar. 31, 1992, to Baltzell discloses a seat cooler apparatus that has a support cylinder mounted upon a rear portion of the cooler located under the seat. As in the above-mentioned Chen device, an umbrella shaft is simply deposited into the cylinder and no further means of more securely attaching the umbrella shaft to the device are shown. This device also is not described as being detachable and/or adjustable.

U.S. Pat. No. 5,255,954 issued on Oct. 26,1993, to Rogers discloses a sun shade umbrella mount for a chair back. An umbrella shaft is supported by a sleeve secured to a frame that hooks to a mounting plate. The mounting plate must be permanently attached to the chair back using bolts, screws, or the like.

U.S. Pat. No. 5,478,041 issued on Dec. 26, 1995, to Mayne, as well as U.S. Pat. No. 5,836,327 issued on Nov. 17, 1998, to Davis, disclose clamping and holding devices suitable for mounting umbrellas to chairs. On both devices, a first clamping arm and a second opposing clamping arm provide a single area of attachment where the device clamps the chair, rather than providing two or more areas of attachment for added stability.

U.S. Pat. No. 5,518,218 issued on May 21, 1996, to Leonard discloses an umbrella-holding tube that can be bound to a chair using bungee cords. An umbrella is bound to the device using a bungee cord as well, and no rigid or non-stretchable fastening means are used for such bindings.

U.S. Pat. No. 5,641,197 issued on June 24,1997, to Springmann discloses a collapsible sports chair that includes a permanently attached umbrella support mechanism having five apertures with bushings that hold an umbrella at a single area of contact with a fixed diameter.

U.S. Pat. No. 6,439,659 issued on Aug. 27, 2002, to Neubauer, Jr. discloses an collapsible portable chair having an opening in a vertical portion of the chair frame such that an umbrella shaft may be deposited therein. The umbrella holder is an integral part of the chair and is thus not removable or repositionable.

U.S. Pat. No. 6,536,733 issued on March 25, 2003 to Sharp discloses a cooler having a permanently fixed and integrated umbrella stand attached to one side. The umbrella stand is simply two rings secured to the cooler such that an umbrella shaft slides through both rings and holds the umbrella in an upright position.

European Pat. Application Publication No. EP 0 860 113 A1 discloses a folding chair having an attached tube for holding an umbrella The device is designed to be attached to and used only with the folding chair described, as opposed to being usable with any chair.

Therefore, each of the prior art umbrella mounting devices is either too cumbersome, requires extended time to install and remove the device, or is incapable of working with an existing folding chair and a conventional umbrella such that the device securely holds the umbrella over the folding chair. There is a need for a portable, light-weight umbrella mounting device that can be easily and quickly installed and removed from a support shaft, e.g., a portable chair leg, wherein the umbrella mounting device securely holds a conventional umbrella in a desired position over a user.

### SUMMARY OF THE INVENTION

The present invention is an accessory device that allows for the ready attachment and detachment of an umbrella, preferably a portable beach umbrella, to a conventional foldable outdoor chair as is used at the beach, when camping, or at picnics. As such, the present invention provides a convenient, portable, and inexpensive mounting option for an individual using an umbrella. The present invention therefore enables a user to temporarily immobilize an umbrella for convenient, hands-free use, even in areas having hard surfaces, such as patios or decks.

The present invention is an umbrella mount having a tube with a top end and a bottom end, a top binder, a bottom binder, a support member, and a securing member. The top binder attaches the tube near its top end to a support shaft, e.g., a leg of a portable, folding chair, whereas the bottom binder attaches the tube near its bottom end to the support shaft. The binders are preferably Velcro-type hook and loop straps that detachably bind the tube to the support shaft. Also, a non-slip collar is positioned on the tube under each binder such that both the top binder and the bottom bind pass over a collar. The collar provides the means for preventing slippage of the straps and preventing slippage of the tube against the support shaft. The support member prevents the umbrella shaft from slipping out the bottom end of the tube. The securing member adjusts the diameter of the cylindrical cavity of the tube to secure the umbrella shaft within the tube.

There are several advantages of the umbrella mount over conventional devices. First, the umbrella mount is easily and quickly installed on and removed from any support shaft. Second, the use of a support member that does not close off the bottom end of the tube allows water and dirt to pass through the tube and not collect within the cylindrical cavity. Third, the umbrella mount is extremely light weight and portable. Fourth, the umbrella mount can be used with any existing foldable chair or support shaft so long as the top and bottom binders are long enough to encompass the support shaft and tube. The present invention does not require any modification to a support shaft nor the use of extra tools in the installation and removal of the umbrella mount.

### BRIEF DESCRIPTION OF THE FIGURES

The present invention is described with reference to the accompanying drawings. In the drawings, like reference numbers indicate identical or functionally similar elements. Additionally, the left-most digit of a reference number identifies the drawing in which the reference number first appears.

FIG. 1 is a perspective view of a preferred embodiment of an umbrella mount of the present invention bound to a chair and holding an umbrella;

FIG. 2 is a perspective view of a preferred embodiment of the umbrella mount of the present invention;

FIG. 3 is a planar side view of a preferred embodiment of the umbrella mount of the present invention bound to a chair and holding an umbrella;

FIG. 4 is a cross-sectional view of the device of FIG. 3 at line 4-4;

FIG. 5 is a cross-sectional view of the device of FIG. 3 at line 5-5;

FIG. 6 is a top end view of a tube and top collar of the present invention; and

FIG. 7 is a perspective view of an alternative embodiment of a bottom end of a tube of the present invention.

### DETAILED DESCRIPTION OF THE PREFERRED EMBODIMENTS

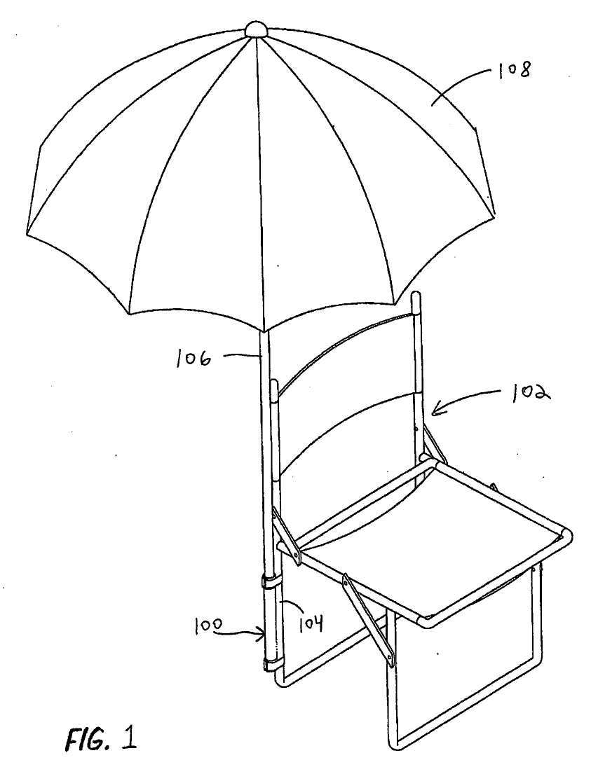

As shown in FIG. 1, the umbrella mount 100 of the present invention is adapted to detachably mount on a support shaft, such as a back leg 104 of a folding chair 102, and to securely hold in place an umbrella shaft 106 of an umbrella 108. However, the depiction of the umbrella mount 100 used in conjunction with the back leg 104 of a folding chair 102 is for convenience purposes only. The umbrella mount 100 works equally as well mounted on any chair leg, table leg, post, or other generally vertical shaft (collectively, “support shaft”), so long as the length of the support shaft 104 is at least about as long as the umbrella mount 100 and the umbrella shaft 106 rises above the support shaft 104.

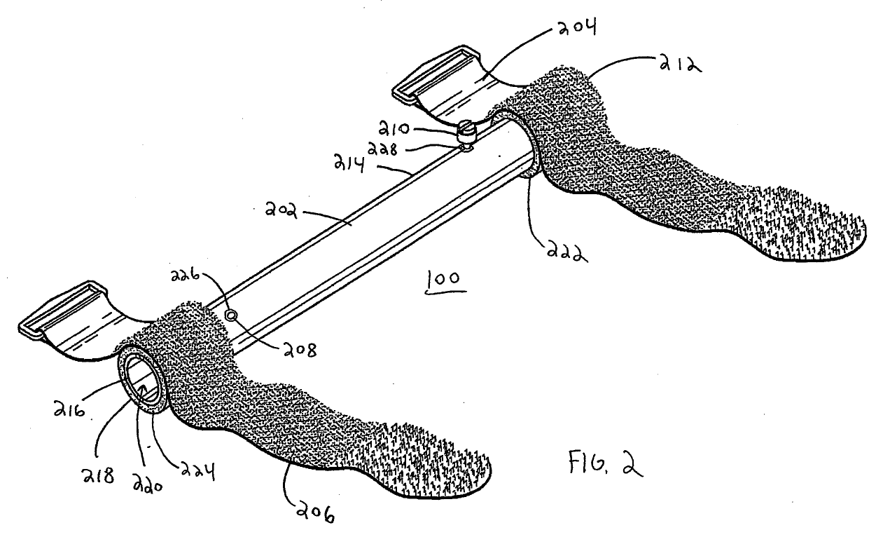

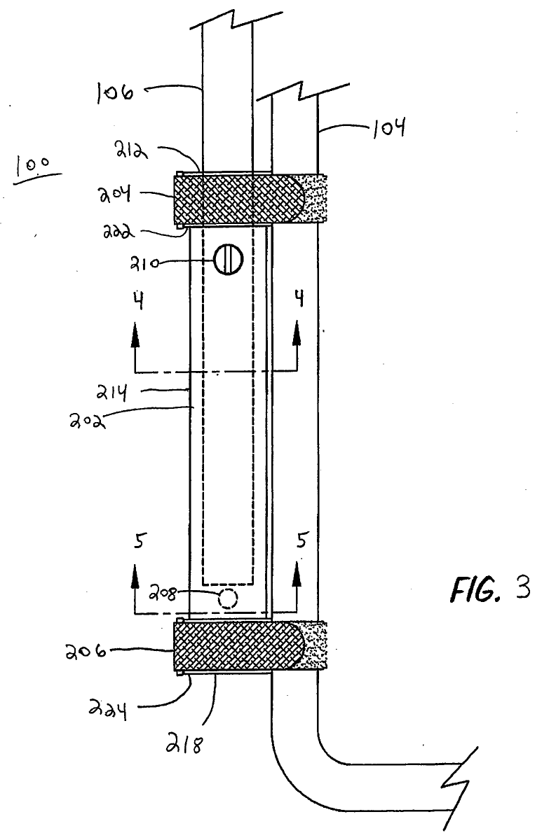

As shown in FIGS. 2-6, a preferred embodiment of the umbrella mount 100 comprises a tube 202, a top cinch strap 204, a bottom cinch strap 206, a machine screw or roll pin 208, and a thumb screw 210. The tube 202 comprises atop end 212, an outer surface 214, an inner surface 216, and a bottom end 218. The tube 202 is defined by a length running from the top end 212 to the bottom end 218, as well as by an inner diameter and an outer diameter, such that the tube defines a cylindrical cavity 220. The tube 202 is preferably made of a plastic or polyvinyl chloride (PVC) tube or pipe, but other materials having comparably similar strength and durability characteristics may alternatively be used, such as metal, wood, rubber, or a composite material. The tube 202 preferably has a length of between about twelve inches and thirteen inches, with an inner diameter of about one inch. PVC pipe is readily commercially available and is well-know to those skilled in the art. The cylindrical cavity 220 of the tube 202 acts as a receptacle into which the umbrella shaft 106 is deposited. The length and size of the tube 202 is described in these terms for convenience only. It would be readily apparent to one of ordinary skill in the relevant art to use a different length and diameter tube 202 depending on the size of the umbrella shaft 106 intended to be used with the umbrella mount 100.

Attached in proximity to or near the top end 212 of the tube 202 is the top cinch strap 204, and attached in proximity to or near bottom end 218 of the tube 202 is the bottom cinch strap 206. Top cinch strap 204 and bottom cinch strap 206 detachably bind umbrella mount 100 to the support shaft 104. Top cinch strap 204 and bottom cinch strap 206 are both preferably conventional Velcro-type straps having hook and loop fasteners about one inch wide and having a length that enables the straps to encompass both the support shaft 104 and the tube 202. Optionally, the top cinch strap 204 and bottom cinch strap 206 have a buckle on one end (as shown in FIG. 2) such that the other end of each strap is inserted through its buckle and folded over the length of the strap, thereby securing the strap in place. Comparable means of binding the umbrella mount 100 to the support shaft 104 may alternatively be used such as bungee cords, straps, snaps, hooks, clamps, clips, fasteners, clasps, securing means, adhesives, pins, pegs, or any combination thereof (collectively, “top binder” and “bottom binder”). Such means of binding should preferably bind at least the top end 212 as well as the bottom end 218 of the tube 202 to the support shaft 104 such that any torsional forces, such as excessive wind, applied to the umbrella 108 do not wrench the umbrella mount 100 away from the support shaft 104. Any number of additional means of binding the umbrella mount 100 to the support shaft 104, as a supplement or supplements at any point or points along the tube 202 between the top binder and the bottom binder may also be used.

Top binder and bottom binder each also preferably operate in conjunction with a non-slip covering, such as a circular collar 222, 224 made of foam, sponge or rubber. The use of a collar 222, 224 is preferred because they can be easily put onto a tube 102 by sliding an end of the tube 102 through each collar 222, 224. See FIG. 6. Each non-slip covering or collar 222, 224 is located on the outer surface 214 of tube 202 near the top end 216 and bottom end 218, respectively, and is preferably, at least in part, between the outer surface 214 of the tube 202 and the top cinch strap 204 and the bottom cinch strap 206, respectively, and between the outer surface 214 of the tube 102 and the support shaft 104. Each non-slip covering or collar 222, 224 absorbs some of the pressure from top cinch strap 204 and bottom cinch strap 206 when they are tightened against a support shaft 104, and also provides additional friction to prevent slippage between the tube 202 and the support shaft 104. Each non-slip covering or collar 222, 224 may be removable from the tube 202, or may be permanently affixed to the outer surface 214 of the tube 202 with an adhesive, glue, two-sided tape, one or more fasteners, or other comparable means of attachment. The collars 222, 224 are preferably wider than the top and bottom cinch straps 204, 206, e.g., are about one and one-half inches wide. Also, the top cinch strap 204 and bottom cinch strap 206 are preferably riveted, or otherwise permanently affixed, to the collars 222, 224, respectively, to prevent them from moving out of position off of the collars 222, 224 and to prevent them from being separated from the tube 202. However, the collars 222, 224 may have alternative sizes and may be connected to the top cinch strap 204 and bottom cinch strap 206, respectively, using alternative attachment means.

In alternative embodiments of the present invention, the use of collars 222, 224 is optional so long as slippage between the tube 202 and the support shaft 104 is prevented in some manner. For example, in an alternative embodiment, the top cinch strap 204 and the bottom cinch strap 206, and/or the outer surface 214 of the top end 216 and the bottom end 218 of tube 202 may have a non-slip or textured surface, or may be coated or wrapped with a non-slip or sticky material or surface, e.g., a coating containing grit, sand, or a sticky substance.

Also in the preferred embodiment, as shown in FIG. 2, a machine screw or roll pin 208 is threaded through a hole 226 preferably near the bottom end 218 of the tube 202. However, the machine screw/roll pin 208 and associated hole 226 may alternatively be placed at another point along the length of the tube 202. The machine screw/roll pin 208 substantially traverses the inner diameter of the tube 202 such that the cylindrical cavity 220 is obstructed to a sufficient extent to retain the umbrella shaft 106 within the tube 202 without slipping out the bottom end 218 of the tube 202. That is, the machine screw/roll pin 208 may protrude through the opposite side of the tube 202 (such that the hole 226 extends through both sides of the tube 202), may extend the length of the entire cylindrical cavity 220, or may extend a portion of the length of the cylindrical cavity 220. The machine screw/roll pin 208 acts as a support member for the umbrella shaft 106. In addition, as shown in FIG. 5, the machine screw/roll pin 208 may be secured to the inner surface 216 of the tube 202 by conventional means, thereby eliminating the need for a hole 226.

As noted above, the machine screw/roll pin 208 may be located at another point along the length of the tube 202. Thus, the machine screw/roll pin 208 would work equally as well (that is, be of such a distance from the bottom end 218 of the tube 202 as to provide the needed support to prevent the umbrella shaft 106 from flipping out of the tube 202) if located within the bottom one-fourth length of the tube 202.

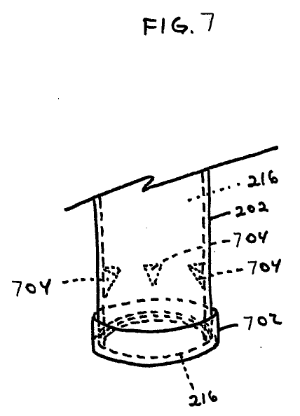

The use of a machine screw/roll pin 208 is for convenience, and any alternative support members or means for supporting the umbrella shaft 106 within the tube 202 would work equally as well. For example, as shown in FIG. 7, one or more flanges or protrusions 704 within the cylindrical cavity 220 of the tube 202 may be used as support members. Alternatively, a cap 702 may be placed on the bottom end 218 of the tube 202 to act as a support member. The cap 702 may be pressure fit onto the bottom end 218 of the tube 202 or may be secured in place by an adhesive, fastener, or the like. Although a cap 702 would work for the intended purpose, it is important to note that the preferred embodiment employs a machine screw/roll pin 208 or similar means for supporting the umbrella shaft 106 that does not fully enclose the bottom end 218 of the tube 202 in order to allow water, dirt, grass, and other debris to pass freely through the tube 202.

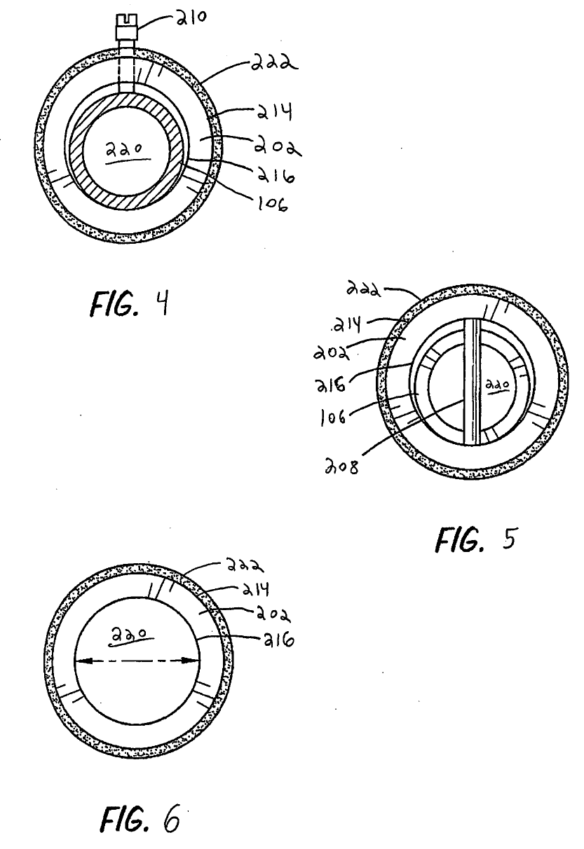

Also in the preferred embodiment, a thumb screw 210 is threaded through a hole 228 preferably near the top binder or top cinch strap 204. As shown in FIG. 4, the thumb screw 210 adjustably obstructs the cylindrical cavity 220 in order to hold the umbrella shaft 106 in place within the tube 202. Specifically, the thumb screw 210 can be loosened such that the umbrella shaft 106 may easily be placed within the tube 202. Then the thumb screw 210 can be tightened such that the end of the thumb screw 210 contacts and presses against the umbrella shaft 106, thereby forcing the umbrella shaft 106 against the opposing inner surface 216 of the tube 202. The umbrella shaft 106 is thus held securely in place within the tube 202.

The use of the thumb screw 210 provides the means for the umbrella mount 100 to accommodate an umbrella shaft 106 of any diameter, so long as the umbrella shaft 106 has a smaller outer diameter than the inner diameter of the tube 202. The thumb screw 210 and associated hole 228 may alternatively be located at another point along the length of tube 202, so long as the thumb screw 210 is closer to the top end 216 of the tube 202 than is the machine screw/roll pin 208. In general, however, the thumb screw 210 is preferably located closer to the top end 216 as opposed to the bottom end 218. The use of thumb screw 210 is for convenience, and any alternative securing member or means for securing the umbrella shaft 106 within the tube 202 would work equally as well. For example, one or more clamps, adjustable pegs, or other adjustable obstructive members or projections may be used as securing members.

In operation, the umbrella mount 100 is bound to a support shaft 104 by first placing the umbrella mount 100 against the support shaft 104 in the desired location such that the tube 202 is aligned with the support shaft 104. The top cinch strap 204 or top binder as well as the bottom cinch strap 206 or bottom binder are then strapped or bound to the support shaft 104. The umbrella shaft 106 is then deposited into the top end 216 of the tube 202 such that the umbrella shaft 106 slides down into the tube 202 and comes to a rest on top of the machine screw/roll pin 208 or support member. The thumb screw 210 or securing member is then adjusted or tightened such that the umbrella shaft 106 is held securely in place within the tube 202. The umbrella 108 may be opened either before depositing the umbrella shaft 106 within the tube 202 or after the securing member is tightened.

The umbrella mount 100 may subsequently be removed from the support shaft 104 by first loosening the thumb screw 210 or securing member, then removing the umbrella shaft 106 from the tube 202 by pulling it upward. The top cinch strap 204 or top binder as well as the bottom cinch strap 206 or bottom binder are then unstrapped or unbound from the support shaft 104, and the umbrella mount 100 at that point is no longer attached to the support shaft 104.

One important advantage of the present invention is that the tube 202 may be rotated in relation to the support shaft 104 to which it is mounted. Thus, a user may rotate the tube 202 prior to securing it to the support shaft 202 in order to make the thumb screw 210 easily accessible or to facilitate the positioning of the umbrella 108 over the chair 102.

The umbrella mount 100 is described in these terms, these dimensions, and using these components for convenience purpose only. It would be readily apparent to one of ordinary skill in the art to manufacture and use a comparable umbrella mount using different dimensions, and/or comparable components.

### CONCLUSION

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. An umbrella mount adapted to hold an umbrella shaft and to be detachably mounted to a support shaft, the umbrella mount comprising:
a tube comprising a top end, an outer surface, an inner surface, and a bottom end, wherein said tube is defined by a length from said top end to said bottom end, an inner diameter, and an outer diameter, and wherein said tube defines a cylindrical cavity;
a top binder attached to said outer surface of said tube near said top end;
a bottom binder attached to said outer surface of said tube near said bottom end;
a support member positioned within said cylindrical cavity and adapted to obstruct a portion of said cylindrical cavity near said bottom end of said tube; and
a securing member positioned within said cylindrical cavity and adapted to adjustably obstruct a portion of said cylindrical cavity near said top binder.

2. The umbrella mount of claim 1, wherein said top binder comprises a top cinch strap.

3. The umbrella mount of claim 2, wherein said top cinch strap comprises a hook and loop fastener.

4. The umbrella mount of claim 1, wherein said bottom binder comprises a bottom cinch strap.

5. The umbrella mount of claim 4, wherein said bottom cinch strap comprises a hook and loop fastener.

6. The umbrella mount of claim 1, further comprising a means for preventing slippage of said tube.

7. The umbrella mount of claim 6, wherein said means for preventing slippage of said tube is located on said outer surface of said tube and is selected from the group consisting of: one or more foam collars, one or more sponge collars, one or more rubber collars, a non-slip coating, a textured surface, and a sticky coating.

8. The umbrella mount of claim 7, wherein said means for preventing slippage of said tube is positioned between said tube and the support shaft.

9. The umbrella mount of claim 7, wherein said means for preventing slippage of said tube is positioned between said top binder and said tube and between said bottom binder and said tube.

10. The umbrella mount of claim 1, wherein said tube is made of a material selected from the group consisting of polyvinyl chloride, plastic, metal, rubber, and a composite material.

11. The umbrella mount of claim 1, wherein said tube has a length between about twelve inches and about thirteen inches.

12. The umbrella mount of claim 1, wherein said tube has an inner diameter of about one inch.

13. The umbrella mount of claim 1, wherein said support member is selected from the group consisting of: one or more protrusions in said cylindrical cavity of said tube, a cap, a roll pin, and a machine screw threaded through a machine screw hole in said tube.

14. The umbrella mount of claim 1, wherein said securing member comprises a thumb screw threaded through a thumb screw hole in said tube.

15. An umbrella mount adapted to hold an umbrella shaft and to be detachably mounted to a support shaft, the umbrella mount comprising:
a tubular means for receiving an umbrella shaft whereby a bottom portion of the umbrella shaft can be removably inserted into said tubular means, and wherein said tubular means has a top end and a bottom end;
a top means for binding said tubular means to the support shaft, wherein said top means is attached to said tubular means near said top end;
a bottom means for binding said tubular means to the support shaft, wherein said bottom means is attached to said tubular means near said bottom end;
a means for supporting the umbrella shaft inside said tubular means whereby the bottom portion of the umbrella shaft does not slide out said bottom end of said tubular means; and
a means for adjustably securing the umbrella shaft inside said tubular means whereby the bottom portion of the umbrella shaft does not slide out said top end of said tubular means.

16. The umbrella mount of claim 15, further comprising a means for preventing slippage of said tubular means.

17. The umbrella mount of claim 16, wherein said means for preventing slippage of said tubular means is located on said outer surface of said tubular means and is selected from the group consisting of: one or more foam collars, one or more rubber collars, a non-slip coating, a textured surface, and a sticky coating.

18. A method for detachably securing an umbrella shaft to a support shaft, the method comprising the steps of:
(a) aligning an umbrella mount with the support shaft, the umbrella mount comprising:
a tube comprising a top end, an outer surface, an inner surface, and a bottom end, wherein said tube is defined by a length from said top end to said bottom end, an inner diameter, and an outer diameter, and wherein said tube defines a cylindrical cavity;
a top binder attached to said outer surface of said tube near said top end;
a bottom binder attached to said outer surface of said tube near said bottom end;
a support member positioned within said cylindrical cavity and adapted to obstruct a portion of said cylindrical cavity near said bottom end of said tube; and
a securing member positioned within said cylindrical cavity and adapted to adjustably obstruct a portion of said cylindrical cavity near said top binder;
(b) detachably binding said umbrella mount to said support shaft using said top binder and said bottom binder;
(c) depositing a bottom portion of the umbrella shaft into said top end of said tube such that the bottom portion of the umbrella shaft slides down into said tube and rests on top of said support member; and
(d) adjusting said securing member such that the bottom portion of the umbrella shaft is held securely in place within said tube.
